(19) United States
(12) Patent Application Publication
(10) Pub. No.: US 2006/0157325 A1
(43) Pub. Date: Jul. 20, 2006

(54) Link and flight assembly for an abrasive blast machine

(76) Inventor: Mat Loutzenheiser, LaGrange, GA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/331,428

(22) Filed: Jan. 12, 2006

Related U.S. Application Data
(60) Provisional application No. 60/643,342, filed on Jan. 12, 2005.

(51) Int. Cl. B65G 17/38

(52) U.S. Cl. 198/851

(57) ABSTRACT

A link and flight assembly for an abrasive blast machine that includes a wedge, a tongue, and a stirrup. A link and flight assembly for an abrasive blast cabinet that is at least partially self-aligning. A link and flight assembly for an abrasive blast cabinet that includes an arrangement in which all end threads of fasteners used to secure the link to the flight are shielded after assembly. A link and flight assembly for an abrasive blast cabinet that includes an arrangement in which no parts of the fasteners used to assemble the links to the flights lie on the working surfaces of the flights.

### RELATED APPLICATIONS

This application claims priority under 35 U.S.C. § 119(e) to U.S. Provisional Application Ser. No. 60/643,342, entitled “Link and Flight Assembly for an Abrasive Blast Machine,” filed on Jan. 12, 2005, which is hereby incorporated by reference in its entirety.

### BACKGROUND OF INVENTION

1. Field of Invention

This invention relates to a machine for cleaning the surfaces of articles, such as metal castings and the like, by throwing abrasive at the surfaces of the articles as they are tumbled about in a cabinet, and, more particularly, to a means for conveying the articles into and out of the cabinet.

2. Discussion of Related Art

The invention is related to a centrifugal blasting machine of the type described in, for example, U.S. Pat. No. 2,104,055 to Peik. Such machines generally comprise a housing enclosing a conveyer formed of a plurality of flights extending between endless chains for travel about a predetermined path. The flights preferably overlap at their edges to form an endless, horizontally disposed belt on which the work or articles to be cleaned are supported. The belt travels around drive sprockets and traction wheels.

The area in which the parts are treated is substantially enclosed by the belt and by other portions of the housing, including a pair of spaced plates and a door for providing access to load and unload the machine. One or more centrifugal blast wheels for throwing abrasive particles into the housing and onto the work piece are mounted on the housing with suitable attachments for feeding and driving the units. A detailed description thereof will not be made since they form no part of this invention and are adequately described in the Peik patent and elsewhere in the art.

As the belt travels around the sprockets and wheels, parts being treated tumble forwardly continuously onto underlying parts, exposing fresh surfaces to the blasting media or other materials being thrown at the parts by the blast wheel(s) mounted on the machine or by other means.

Various improvements to the basic centrifugal blasting machine have been proposed. For example, U.S. Pat. No. 2,909,012 to Barnes describes a tumbling mill or centrifugal blasting machine which maintains the flight bars of the conveyor substantially in a continuous contacting relationship to provide a continuous conveyor free of openings between the flights during travel. U.S. Pat. No. 3,079,735 to Freeman provides a continuous conveyor which is free of openings between the flights by virtue of a flexible sealing element provided for that purpose. And U.S. Pat. No. 4,476,655 to Ansbaugh teaches a link and flight assembly in which the use of blast resistant materials is minimized to reduce costs.

### SUMMARY OF INVENTION

According to one embodiment of the invention, a link and flight assembly comprises a wedge, a tongue, and a stirrup.

According to another embodiment of the invention, a link and flight assembly for an abrasive blast cabinet is at least partially self-aligning.

According to another embodiment of the invention, a link and flight assembly for an abrasive blast cabinet comprises an arrangement in which all end threads of fasteners used to secure the links to the flights are shielded after assembly.

According to another embodiment of the invention, a link and flight assembly for an abrasive blast cabinet comprises an arrangement in which no parts of the fasteners used to assemble the links to the flights lie on the working surfaces of the flights.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a fragmentary portion of a prior art blast machine suitable for use with the invention.

FIG. 2 is an exploded view of a portion of a prior art link and flight assembly.

FIG. 3 is an exploded view of a portion of one embodiment of a link and flight assembly according to the invention.

FIG. 4A is a lower perspective view of one embodiment of a link according to the invention.

FIG. 4B is an upper perspective view of one embodiment of a link according to the invention.

FIG. 5 is a lower perspective view of a portion of one embodiment of a flight according to the invention.

FIG. 6 is a side view of a portion of the flight of FIG. 5.

FIG. 7A is a sectional view taken along line A-A of FIG. 6.

FIG. 7B is a sectional view taken along line B-B of FIG. 6.

FIG. 8 is a perspective view of one embodiment of a wedge according to the invention.

FIG. 9A is a side view of the wedge of FIG. 8.

FIG. 9B is a front view of the wedge of FIG. 8.

FIG. 10 is a sectional view of one embodiment of an assembled link and flight assembly according to the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of terms such as “including,” “comprising,” “having,” “containing,” and “involving” is meant to encompass the items listed thereafter and equivalents thereof, as well as additional items.

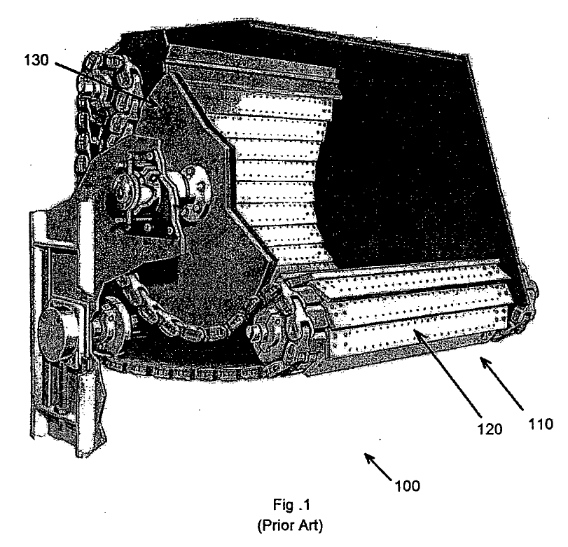

FIG. 1 illustrates a conveyor and drum portion of a prior art blasting machine 100 that may suitably employ the features of this invention. The machine comprises a housing enclosing a belt 110 that is formed of a plurality of flight and link assemblies 120 and travels about a predetermined path around drive sprockets and/or traction wheels, supporting articles to be cleaned. The area in which the parts are treated is substantially enclosed by the belt 110 and other portions of the housing, including a pair of spaced plates 130 (one of which is illustrated), and a door (not shown). One or more centrifugal blast wheels (also not shown) for throwing abrasive particles into the housing and onto the work are mounted on the housing. For a more detailed explanation of the blast cabinet and operation thereof reference is made to the aforementioned U.S. Pat. Nos. 2,909,012 and 3,079,735.

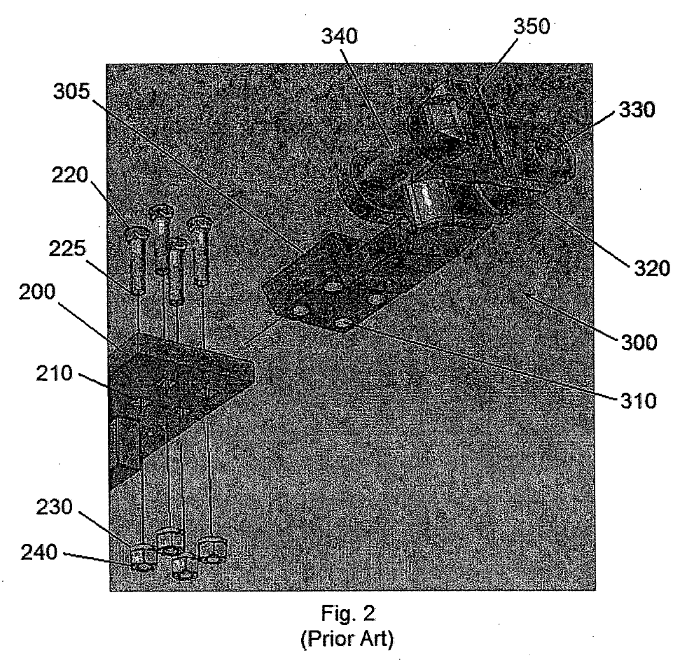

FIG. 2 illustrates a prior art link and flight arrangement. Flight 200 is generally T-shaped in cross section and includes of a number of flight mounting holes 210. Link 300, in this case a right-hand link, includes a mounting pad 305 that includes a number of link mounting holes 310 in an arrangement corresponding to that of the flight mounting holes 210. Link 300 also includes a body portion 320 that includes a pin bore 330 on one end portion and a removable link pin 340 on the other end portion. The removable link pin 340 is held in place by a securing pin 350.

The prior art link and flight assembly of FIG. 2 is assembled by aligning the flight mounting holes 210 with the link mounting holes 310, passing a number of bolts 220 through the aligned holes, and securing the bolts 220 with nuts 240 and lock washers 230. A substantial disadvantage of this arrangement is that gaps between the bolts 220 and the flight and link mounting holes 210, 310 allow for a certain degree of misalignment, or “play,” between the flight 200 and the link 300. Misalignment may result in binding, jamming, and/or premature wear of the links, flights, drive sprockets, and/or traction wheels.

In practice, the play inherent in this prior art system requires that the operator loosely secure the flights 200 and links 300, run the machine for a period of time (often in excess of 15 minutes) to allow the flights 200 and links 300 to align themselves, and then stop the machine and tighten all of the bolts. As there may be up to four bolts 220 for each end of each flight 200, and because there may be a large number of flights 200 requiring service at a given time, this process can be very time consuming and can result in significant down time for the entire machine.

Another disadvantage of the prior art arrangement of FIG. 2 is that it requires distinct right-handed and left-handed links. Flights 200 are inclined away from the direction of travel of the belt, so as to not interfere with the tumbling action when moving in the forward direction and to aid in unloading with a pushing action when moving in the reverse direction. This inclination is achieved in the prior art arrangement by angling the mounting pad 305 of the link 300, such that the top of the flight 200 will rest at an angle relative the path of the belt. In order to achieve the proper angle, however, the mounting pads of right-hand links must be inclined in a direction opposite that of the mounting pads of the left-hand links.

Another problem with the prior art arrangements is the number of parts required. In the particular arrangement of FIG. 2, for example, a complete link and flight assembly requires, at least, a flight, a right-hand link assembly, a left-hand link assembly, eight bolts, eight lock washers, and eight nuts. All of these various parts must be stocked for service.

An additional problem resulting from the prior art arrangement of FIG. 2 is that the threaded ends 225 of the bolts 220 are exposed, as are the heads of the bolts that lie on the abrasive contacting side of the flights. During operation of the machine, these exposed parts are subjected to contact with the abrasive material, which works its way throughout the machine. When the threaded ends 225 become clogged with or worn by the abrasive, it may become impossible to remove the bolts 220 without cutting them off with a torch, a process that takes time, may cause damage to links, and carries the various risks associated with the use of open flames.

A further problem that results from the prior art arrangements is that the nuts 230, which lie on the lower face of the associated flights 200, are usually only accessible through a small access door on the side of the machine with a right angle wrench or socket. This arrangement allows for only limited access and wrench motion. The problem is compounded by the number of nuts that must be removed to disengage even a single link.

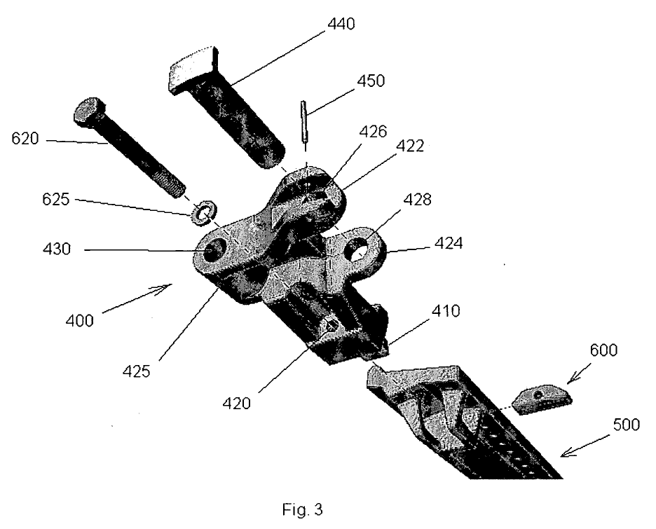

The inventive flight and link assembly, one embodiment of which is illustrated in FIGS. 3-10, solves many of the problems of the prior art arrangements.

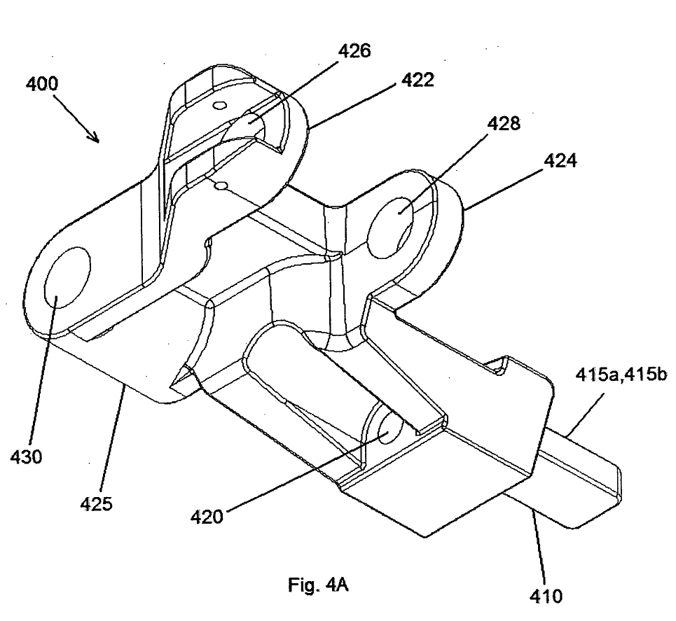

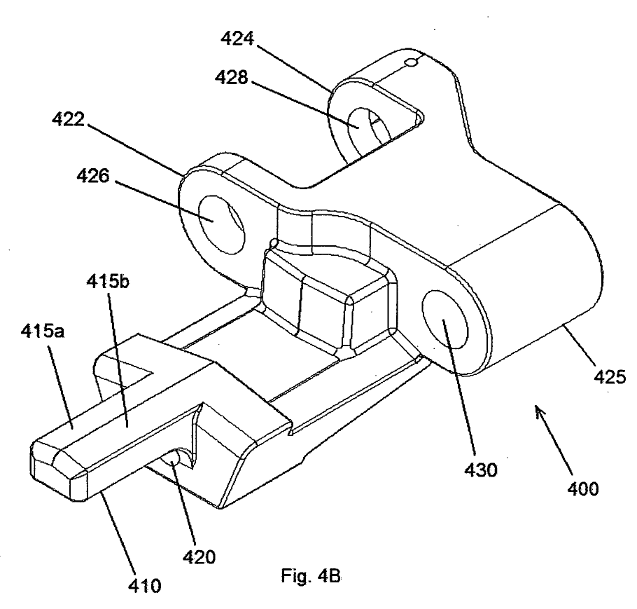

In the new arrangement, the link 400, shown most clearly in FIGS. 4A and 4B, includes an alignment shoe 410, which extends from the link generally in the direction of the length of the flight 500 (as shown in FIG. 3). The link 400 also includes a wedge bolt bore 420, which extends through the link, also generally in the direction of the length of the flight 500. The alignment shoe 410 has upper surfaces 415a, 415b that form a peak when viewed in a direction along the length of the alignment shoe 410. In this embodiment, the upper surfaces 415a, 415b form an angle of approximately 160 degrees. This is in contrast to the prior art arrangement, in which the top surfaces of the mounting pads 305, which correspond to the upper surfaces 415a, 415b, are flat and angled either away from or in the direction of the line of travel of the link, depending on whether the link was right-handed or left-handed. The precise angle is not critical, however, and it may vary depending on the application. The link 400 also includes a body portion 425 that carries a pin bore 430 on one end and has ears 422, 424 on the other end that include corresponding ear bores 426, 428. A removable link pin 440 passes through the ear bores 426, 428 and is retained in place by a securing pin 450.

In one embodiment, link 400 is a heat treated steel casting with maximum tensile strength and added abrasion resistant properties in the wedge bolt bore 420 and the ears 422, 424. The particular size and shape of the link 400 and its various elements may vary depending on the application.

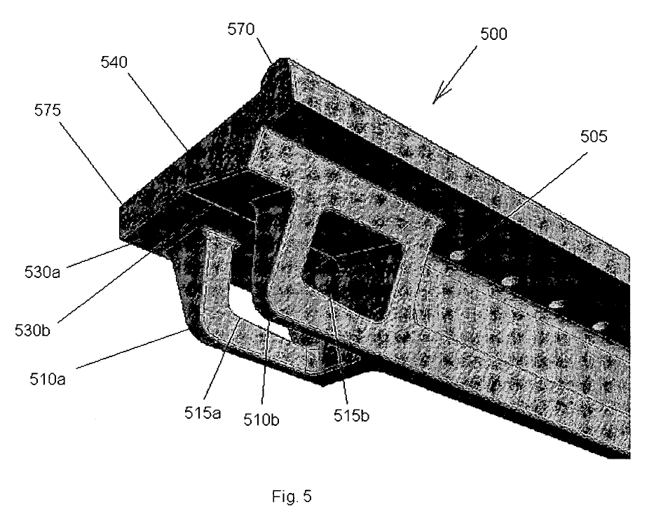

As shown in FIGS. 5-7, the flight 500 of the illustrative arrangement is generally T-shaped in cross-section and has drain holes 505. The flight 500 also has a lip 570 and a shelf 575, designed to provide an overlap of the flights in operation, although other embodiments may not include this feature. Either end of the flight 500 includes a pair of stirrups 510a, 510b. The stirrups 510a, 510b extend from and reconnect to mounting surfaces 530a, 530b on the underside of the flight 500.

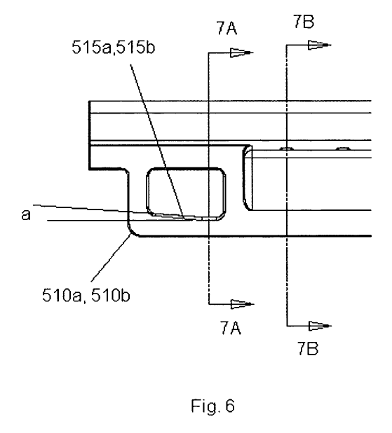

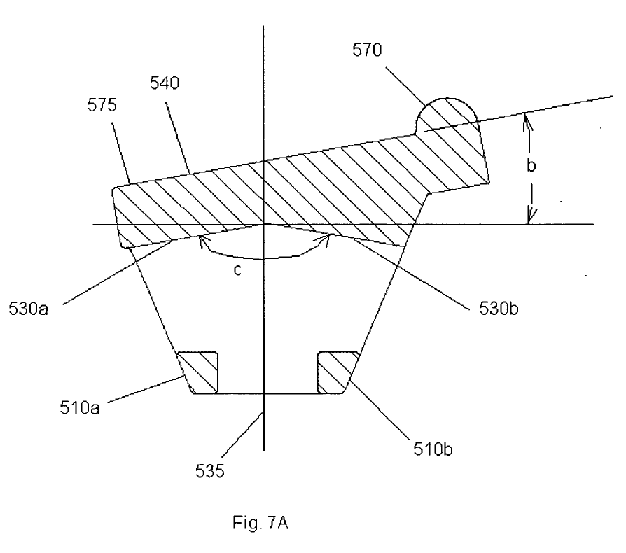

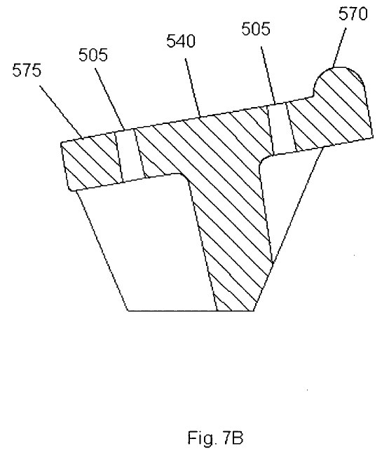

When viewed in cross-section, as in FIG. 7, mounting surfaces 530a, 530b form an angle “c” of approximately 160 degrees. This angle corresponds to the angle formed between upper surfaces 415a, 415b. As with that angle, however, the angle “c” is not critical and may vary depending on the application. Upper surface 540 of the flight 500 forms an angle “b” of approximately 10 degrees with a line perpendicular to line 535, which bisects the angle formed by the mounting surfaces 530a, 530b. This angle is also not critical. In this embodiment, portions of inner surfaces 515a, 515b of the stirrups 510a, 510b, when viewed in a direction perpendicular to the length of the flight 500, as in FIG. 6, form an angle “a” of approximately 5 degrees with the mounting surface 510. This angle may also be varied for different applications.

In one particular embodiment, the flight 500 is primarily a work-hardened 11-14% manganese material. The specific size and shape of the flight 500 and its various elements will vary depending on the application.

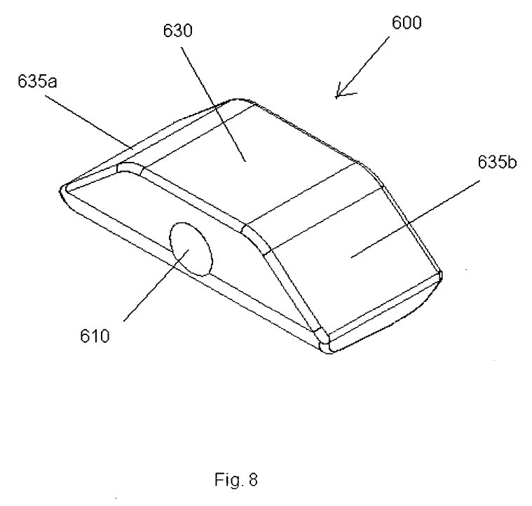

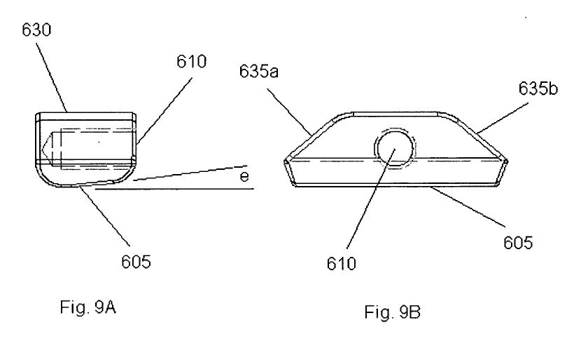

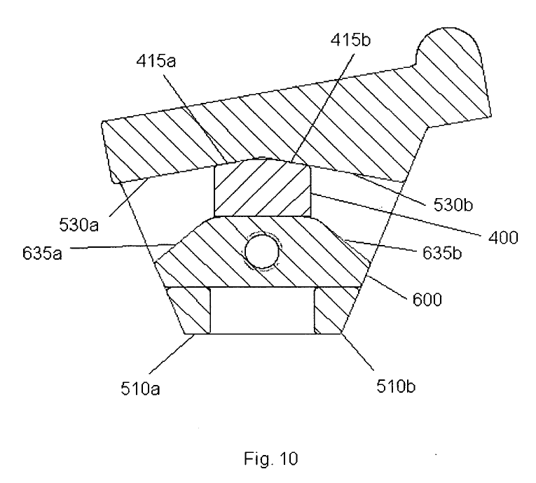

A third component of the assembly is a wedge 600, as seen in FIGS. 8 and 9. The wedge 600 includes threaded wedge bore 610 for receiving wedge bolt 620. In the preferred embodiment, threaded wedge bore 610 does not extend through wedge 600.

When viewed from the side, as in FIG. 9A, wedge 600 has a tapered surface 605 that forms an angle “e” of approximately 5 degrees with the top surface 630 of the wedge 600. This angle “e” corresponds to angle “a” of the portions of inner surfaces 515a, 515b of the stirrups 510a, 510b and may vary in differing applications. The width of the face of wedge 600 that includes the threaded bore 610 is wider than the gap between the stirrups 510a, 510b, such that the wedge can span the stirrups 510a, 510b.

As can be appreciated from FIG. 3, the flight and link assembly is assembled by inserting alignment shoe 410 between the stirrups 510a, 510b, such that the upper surfaces 415a, 415b of the alignment shoe 410 (as shown in FIG. 4B and described above) contact the mounting surfaces 530a, 530b (as shown in FIG. 5 and described above). The wedge 600 is passed through the stirrups 510a, 510b under the alignment shoe 410, so that the wedge bolt bore 420 is in registration with the threaded bore 610 (as shown in FIG. 8). Wedge bolt 620 is passed through lock washer 625 and wedge bolt bore 420, and into threaded bore 610.

As the wedge bolt is tightened, the wedge 600 is drawn in the direction of the link, causing the wedge 600 to be pulled tightly against the stirrups 510a, 510b and, also, causing the upper surfaces 415a, 415b of the alignment shoe 410 to be pushed tightly against the mounting surfaces 530a, 530b. The relationship between the various components after assembly can be seen most clearly in FIG. 10.

Because the wedge 600 draws the link and flight together in at least partially the correct relationship, there is a reduced need, as in prior art systems, to loosely assemble the link and flight, run the machine for a period of time, and then tighten the fasteners. In some embodiments, the wedge and stirrup arrangement can provide for a partially self-aligning link and flight system, while in others the wedge and stirrup arrangement can provide for a fully self-aligning link and flight system.

Due to the fewer number of overall parts, the new link and flight arrangement is more easily assembled and maintained than in past systems. One entire assembly requires only a flight, two links, two wedges, two bolts, and two lock washers.

Another important advantage of the new system is that there are no exposed end threads in the fastening system. Because the end of the wedge bolt 620 is contained within the closed-end threaded wedge bore 610, the end threads are protected from the harmful effects of the abrasive media. While it may be that some intermediate threads may be exposed, degradation of these threads will not impact the ability to remove the link from the flight. In addition, unlike in the prior art arrangements, there are no exposed fastener heads on the working surfaces of the links. This further reduces wear on the fasteners and associated costs.

Finally, with respect to disassembling the link and flight, the problem of the multiple nuts being difficult to access as a result of lying parallel to the plane of the flight is eliminated. The single wedge bolt 620 is accessible from the side of the machine, lies in a plane that is perpendicular to the face of the flights, and therefore can be removed easily with a straight impact driver.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A link and flight assembly comprising:
an elongated flight comprising a stirrup and a mating surface;
a link comprising an alignment shoe adapted to mate with the mating surface;
a wedge positioned within the stirrup; and
a wedge bolt passing through the link and into the wedge.

2. The link and flight assembly of claim 1, wherein the link is a heat treated steel casting.

3. The link and flight assembly of claim 1, wherein the flight comprises a manganese material.

4. The link and flight assembly of claim 1, wherein the wedge bolt is threaded and the wedge comprises a threaded bore.

5. The link and flight assembly of claim 4, wherein the threaded bore does not extend through the wedge.

6. The link and flight assembly of claim 1, wherein the wedge and stirrup have complementary tapered surfaces.

7. The link and flight assembly of claim 1, wherein the flight comprises a working surface and the axis of the wedge bolt is generally parallel to the working surface.

8. The link and flight assembly of claim 1, wherein the upper surface of the alignment shoe forms a peak.

9. A link and flight assembly for a blast cabinet comprising:
an elongated flight; and
a link positioned at one end of the flight,
wherein the flight and the link are at least partially self-aligning.

10. The link and flight assembly of claim 9, wherein the link is a heat treated steel casting.

11. The link and flight assembly of claim 9, wherein the flight comprises a manganese material.

12. The link and flight assembly of claim 9, wherein the link comprises an alignment shoe.

13. The link and flight assembly of claim 12, wherein the upper surface of the alignment shoe forms a peak.

14. A link and flight assembly for a blast cabinet comprising:
an elongated flight;
a link; and
a fastener having a threaded end, wherein the threaded end of the fastener is shielded.

15. The link and flight assembly of claim 14, wherein the link is a heat treated steel casting.

16. The link and flight assembly of claim 14, wherein the flight comprises a manganese material.

17. The link and flight assembly of claim 14, wherein the fastener is threaded.

18. The link and flight assembly of claim 17, wherein the end of the threaded fastener is shielded by insertion into a wedge.

19. The link and flight assembly of claim 14, wherein the flight comprises a working surface and the axis of the fastener is generally parallel to the working surface.

20. A link and flight assembly for a blast cabinet comprising:
an elongated flight having a working surface;
a link; and
a fastener for connecting the link to the flight, wherein no portion of the fastener is visible on the working surface.

21. The link and flight assembly of claim 20, wherein the link is a heat treated steel casting.

22. The link and flight assembly of claim 20, wherein the flight comprises a manganese material.

23. The link and flight assembly of claim 20, wherein the fastener is a bolt.

24. The link and flight assembly of claim 20, wherein the flight comprises a working surface and the axis of the fastener is generally parallel to the working surface.
